(19) United States
(12) Patent Application Publication
(10) Pub. No.: US 2005/0242068 A1
(43) Pub. Date: Nov. 3, 2005

(54) Systems and methods for providing plasma arc torch parts and inventories to distributors

(76) Inventors: John A. Boisvert, Lebanon, NH (US); Christopher J. Conway, Wilmot, NH (US); Roger W. Hewett, Plainfield, NH (US); Allan H. Holst, Austin, MN (US); Kevin D. Horner-Richardson, Cornish, NH (US); Chris G. Jackson, White River Junction, VT (US); Darrin H. MacKenzie, Windsor, VT (US); Fred A. Rogers, Enfield Center, NH (US)

Correspondence Address: HARNESS, DICKEY, & PIERCE, P.L.C, 7700 BONHOMME, STE 400, ST. LOUIS, MO, 63105, US

(21) Appl. No.: 10/827,393

(22) Filed: Apr. 19, 2004

(51) Int. Cl. B23K 10/00

(52) U.S. Cl. 219/121.36; 705/28

(57) ABSTRACT

In a plasma arc torch parts distribution network, the present invention provides a method of providing plasma arc torch parts for use in a single plasma arc torch model through a plurality of distribution channels. In one form of the present invention, the method comprises the steps of providing a first set of plasma arc torch parts to a replacement parts distributor, providing a second set of plasma arc torch parts to an original equipment manufacturer, and providing a third set of plasma arc torch parts to a select original equipment manufacturer. The first, second, and third set of plasma arc torch parts are not interchangeable such that the replacement parts distributor, the original equipment manufacturer, and the select original equipment manufacturer maintain separate inventories of plasma arc torch parts.

### FIELD OF THE INVENTION

The present invention relates generally to replacement parts for plasma arc torches and more particularly to systems and methods for providing the replacement parts and related inventories to individual parts distributors.

### BACKGROUND OF THE INVENTION

The industry for plasma arc torches is, in part, comprised of plasma torch companies that typically design, manufacture, and support plasma arc torches, systems, and replacement parts. Some of the replacement parts are commonly referred to as “consumables” due to their limited life capacity after repeated operations, and other replacement parts are made available in the event of damage or long-term wear and tear of other components of the plasma arc torch and/or system. The industry further includes “non-genuine” plasma torch companies that generally manufacture plasma arc torches and replacement parts based on designs of the plasma torch companies. Additionally, the industry includes replacement parts distributors that receive inventories of plasma arc torches, systems, and replacement parts from the plasma torch companies and the non-genuines, and then sell the torches, systems, and replacement parts to the end users, in addition to providing product support functions. The industry also includes original equipment manufacturers (OEMs) that provide entire shape cutting systems to the end users, wherein the OEM selects a particular plasma torch company to provide the plasma torch(es), lead(s), power supply/supplies, replacement parts, and technical support for the cutting system being installed for the end user. Accordingly, the plasma arc torches and replacement parts are provided to the end user either through a replacement part distributor and/or through the OEM. The plasma arc torch companies typically do not sell plasma arc torches and replacement parts directly to the end user, however, the non-genuine plasma torch companies often sell plasma arc torches and replacement parts directly to the end user.

As a result, the sales and distribution of replacement parts for plasma arc torches from the plasma torch companies to the end users typically occurs through a number of different distribution channels. For example, for a given plasma arc torch system, a percentage of the replacement parts may be sold to several replacement parts distributors and/or another percentage may be sold to several OEMs. In yet another distribution channel, all of the plasma arc torch replacement parts are sold to a select OEM, which is typically a high volume OEM that has exclusivity in providing a particular plasma arc torch to the end user. Therefore, for a given plasma arc torch model, there may be a plurality of replacement parts distributors and a plurality of OEMs competing for the same replacement parts business, or in the case of a select OEM, only the select OEM receives all of the replacement parts business.

In such a distribution network, the replacement parts distributors may have gained a certain percentage of replacement parts, e.g., 40%, and the OEMs may have gained another percentage of the replacement parts, e.g., 60% through their respective aggressiveness in the market. In the case of the select OEM, however, 100% of the replacement parts business is guaranteed due to the exclusivity. Accordingly, the percentage of replacement parts business is a function of each distributor's aggressiveness in the market in cases without a select OEM.

An additional aspect of the replacement parts market includes a second tier, or level, of distribution, wherein the replacement parts are sold by the plasma torch company to the OEM, and the OEM then sells the replacement parts to a distributor, who then distributes the replacement parts to the end users. Accordingly, an additional level of distribution is added to the distribution channel between the plasma torch company and the end users. However, in order to sell the replacement parts to the end users at approximately the same cost, the plasma torch company is often forced to provide a greater discount to the OEM such that each party in the distribution channel is selling the replacement parts at some profit. Unfortunately, the profit for each party is reduced with such an additional level of distribution, which is a function of the business environment. Accordingly, the distributors for plasma arc torch replacement parts include several replacement parts distributors, several OEMs, or a single, select OEM, within several levels of distribution.

Accordingly, a need exists in the art for a more efficient method of providing replacement parts and inventories to the variety of replacement part distributors within the plasma arc torch market.

### SUMMARY OF THE INVENTION

In one preferred form, in a plasma arc torch parts distribution network, the present invention provides a method of providing plasma arc torch parts for use in a single plasma arc torch model through a plurality of distribution channels. The method comprises the steps of providing a first set of plasma arc torch parts to a first distributor and providing a second set of plasma arc torch parts to a second distributor, wherein the first set of plasma arc torch parts are not interchangeable with the second set of plasma arc torch parts such that the first and second distributors maintain separate inventories of plasma arc torch parts.

In another form of the present invention as it relates to a plasma arc torch parts distribution network, a method of providing plasma arc torch parts for use in a single plasma arc torch model through a plurality of distribution channels is provided. The method comprises the steps of providing a first set of plasma arc torch parts to a replacement parts distributor, providing a second set of plasma arc torch parts to an original equipment manufacturer, and providing a third set of plasma arc torch parts to a select original equipment manufacturer. The first, second, and third set of plasma arc torch parts are not interchangeable such that the replacement parts distributor, the original equipment manufacturer, and the select original equipment manufacturer maintain separate inventories of plasma arc torch parts.

In yet another form of the present invention, a series of plasma arc torch parts are provided for use by a plurality of distributors in a single plasma arc torch model. The series comprises a first set of plasma arc torch parts for use by a first distributor and a second set of plasma arc torch parts for use by a second distributor, wherein the first set of plasma arc torch parts are not interchangeable with the second set of plasma arc torch parts.

The present invention also provides a system for inhibiting use of an incorrect set of replacement parts in a plasma arc torch. The system comprises a first set of replacement parts defining a first set of mating geometrical features and a second set of replacement parts defining a second set of mating geometrical features, wherein when at least one of the first set of mating geometrical features is engaged with at least one of the second set of mating geometrical features, the plasma arc torch develops a cooling fluid leak to inhibit further use of the plasma arc torch.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram illustrating a distribution network for plasma arc torch parts in accordance with the principles of the present invention;

FIG. 2 is a perspective view of an exemplary plasma arc torch in accordance with the principles of the present invention;

FIG. 3 is a cross-sectional view, taken along line A-A of FIG. 2, of the exemplary plasma arc torch in accordance with the principles of the present invention;

FIG. 4a is a cross-sectional view of a single plasma arc torch model comprising one set of parts and constructed in accordance with the principles of the present invention;

FIG. 4b is a cross-sectional view of the single plasma arc torch model comprising a second set of parts and constructed in accordance with the principles of the present invention;

FIG. 4c is a cross-sectional view of the single plasma arc torch model comprising a third set of parts and constructed in accordance with the principles of the present invention;

FIG. 5a is a cross-sectional view of a first cartridge body with an incorrect second set of parts disposed therein in accordance with the principles of the present invention;

FIG. 5b is a cross-sectional view of the first cartridge body with an incorrect third set of parts disposed therein in accordance with the principles of the present invention;

FIG. 6a is a cross-sectional view of a second cartridge body with an incorrect first set parts disposed therein in accordance with the principles of the present invention;

FIG. 6b is a cross-sectional view of a second cartridge body with an incorrect third set parts disposed therein in accordance with the principles of the present invention;

FIG. 7a is a cross-sectional view of a third cartridge body with an incorrect first set parts disposed therein in accordance with the principles of the present invention; and

FIG. 7b is a cross-sectional view of a third cartridge body with an incorrect second set parts disposed therein in accordance with the principles of the present invention.

Corresponding reference numerals indicate corresponding parts throughout the several views of the drawings.

### DETAILED DESCRIPTION OF THE PREFERRED EMBODIMENTS

The following description of the preferred embodiments is merely exemplary in nature and is in no way intended to limit the invention, its application, or uses.

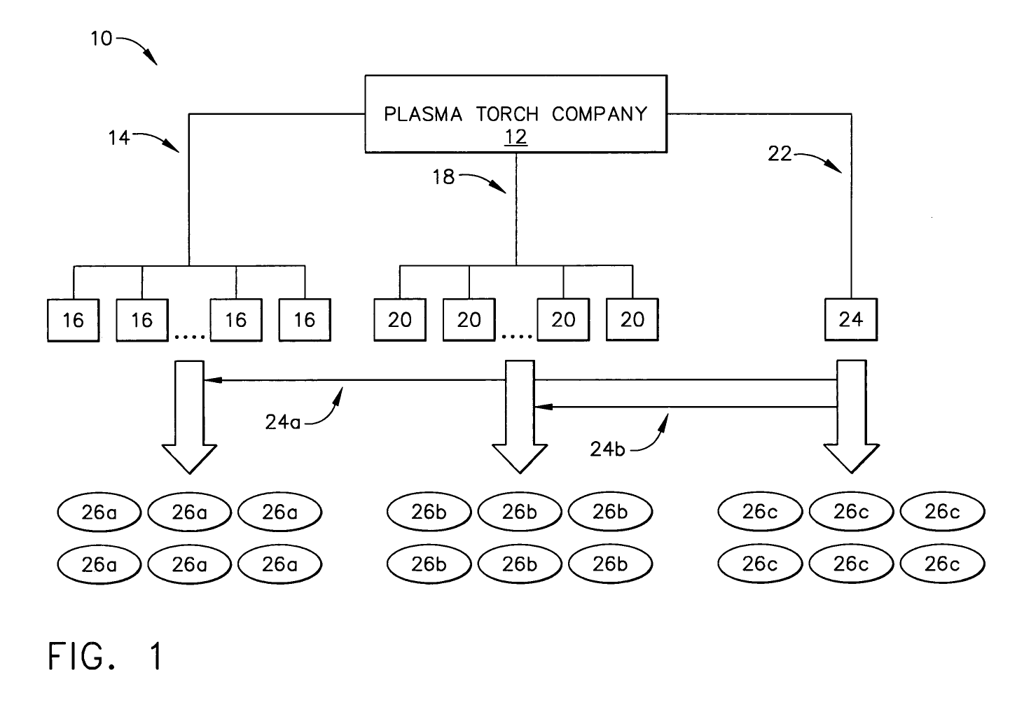

Referring to the drawings, a plasma arc torch parts distribution network according to the present invention is illustrated and indicated by reference numeral 10 in FIG. 1. Generally, the distribution network 10 comprises a plasma torch company 12, which may be a genuine plasma torch company or a non-genuine, that manufactures replacement parts for plasma arc torches. It should be understood that the plasma torch company 12 also manufactures other components such as plasma arc torches, power supplies, and overall plasma arc torch systems. Further, the term “replacement parts” should be construed to include parts or components that are repaired or replaced within a plasma arc torch, power supply, and/or system. As such, the replacement parts include both consumables and non-consumables, the latter of which are replaced or repaired after longer intervals and on a relatively non-predictable basis as compared with consumable components. Additionally, use of the terms “parts” and/or “components” throughout should also be construed to mean replacement parts.

As further shown, the distribution network 10 also comprises a distribution channel 14 to a first set of distributors 16, a second distribution channel 18 to a second set of distributors 20, and a third distribution channel 22 to a third distributor 24. Preferably, the first distributors 16 are replacement parts distributors, the second distributors 20 are OEMs, and the third distributor 24 is a select OEM as previously described. Accordingly, the replacements parts manufactured by the plasma torch company 12 are distributed through a plurality of distribution channels 14, 18, and 22, and ultimately to the end users 26a, 26b, and 26c. Additionally, another level of parts distribution may occur where the select OEM sells replacement parts to either the first set of distributors 16 and/or the second set of distributors 20, who then sell the replacement parts to the end users 26a, 26b, and 26c, as shown by the lines 24a and 24b. Furthermore, it should be understood that the present invention is applicable to at least two distribution channels with two distributors and can include three or more distribution channels and distributors, in addition to several levels of distribution (i.e., 24a and 24b). Therefore, the preferred form of the present invention comprising three distribution channels through the replacement parts distributors 16, the OEM distributors 20, and the select OEM distributor 24 should not be construed as limiting the scope of the present invention.

According to the principles of the present invention, the end users 26a, 26b, and 26c each employ a single plasma arc torch model. As used herein, the term “single plasma arc torch model” should be construed to mean a plasma arc torch design wherein the overall design and operating parameters are substantially the same yet certain design features, such as those that are illustrated in greater detail below, may vary slightly. Additionally, the operating parameters may include, by way of example, amperage, starting method, gas type(s), gas flow rate(s), type of cutting equipment (manual or automated), operating mode, material type of the replacement part(s), and workpiece thickness and material type.

In further accordance with the principles of the present invention, a first set of parts are manufactured by the plasma torch company 12 for distribution by the first distributors 16 to the end users 26a, a second set of parts are manufactured for distribution by the second distributors 20 to the end users 26b, and a third set of parts are manufactured for distribution by the third distributor 24 to the end users 26c, based on a single plasma arc torch model. Each set of parts comprises certain design features such that the first set of parts, the second set of parts, and the third set of parts are not interchangeable, which renders the plasma arc torch inoperable if the wrong set of parts are installed by the end user. Generally, the design features that render the plasma arc torch inoperable, which are described in greater detail below, include physical attributes that prevent installation of the replacement parts, e.g. interferences and/or gaps, electrical gaps that prevent electrical connection(s), physical attributes that cause a leak of cooling fluid or working gas, physical attributes that prevent engagement of a parts-in-place (PIP) switch, and electronic or magnetic keys. It should be understood that a variety of means may be employed to prevent the interchangeability of parts for a single plasma arc torch model, and as such, the design features as illustrated and described herein should not be construed as limiting the scope of the present invention.

Therefore, the distribution network 10 provides distinct distribution channels wherein the replacement parts distributors 16 compete amongst themselves for the replacement parts business from the end users 26a, the OEM distributors 20 similarly compete amongst themselves for the replacement parts business from the end users 26b, while the select OEM enjoys exclusivity of the replacement parts business from the end users 26c. Such a distribution network 10 provides a greater degree of flexibility for the plasma torch company 12 in accommodating the individual needs of the distributors while maintaining a common plasma arc torch model across a plurality of end users.

Although the present invention has been described with regard to replacement parts for plasma arc torches, it should be understood that the distribution network as described herein may be employed with other components of a plasma arc torch system. These other components may include, by way of example, power supplies, plasma arc torches, and support systems, among others. Therefore, the specific discussion relating to replacement parts should not be construed as limiting the scope of the present invention.

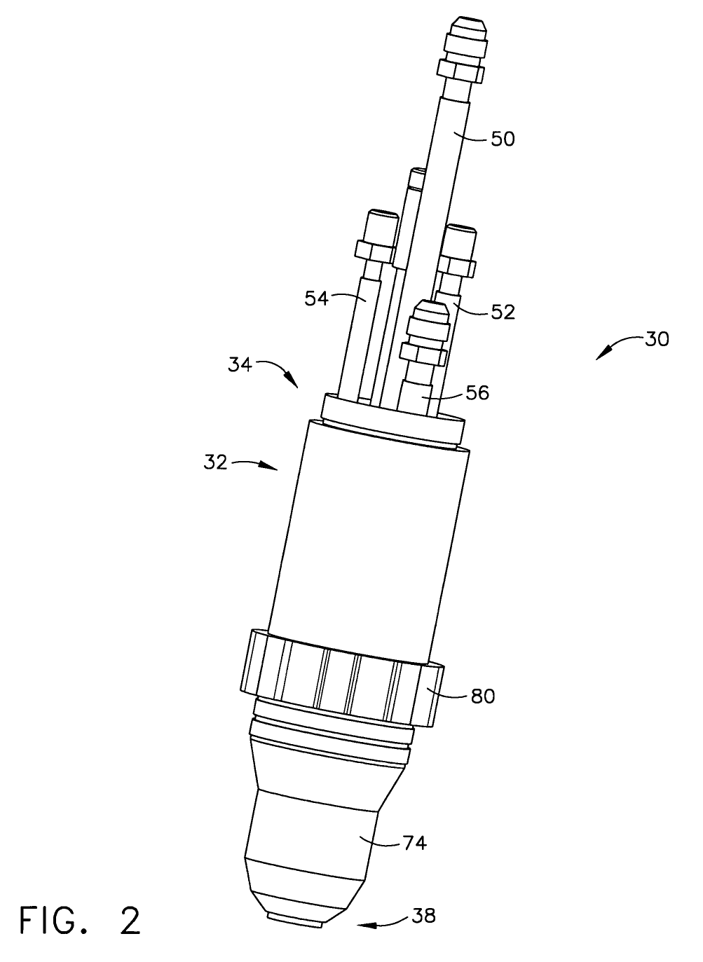

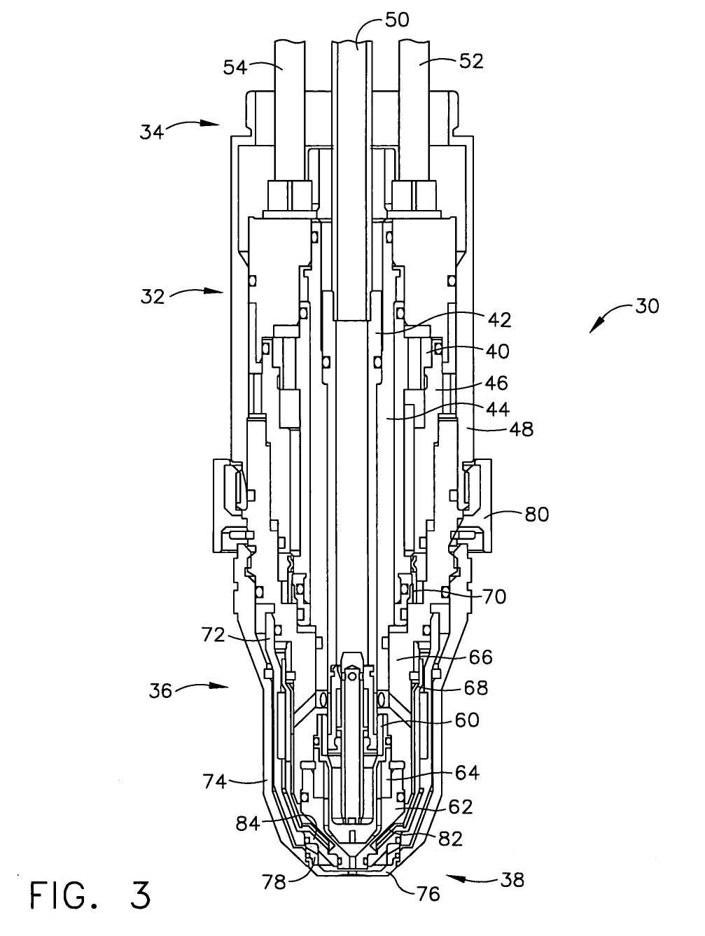

Referring now to FIGS. 2 and 3, an exemplary plasma arc torch comprising design features that prevent interchangeability of replacement parts is illustrated and generally indicated by reference numeral 30. The exemplary plasma arc torch 30 generally comprises a torch head 32 disposed at a proximal end 34 of the plasma arc torch 30 and a plurality of components 36 secured to the torch head 32 and disposed at a distal end 38 of the plasma arc torch 30 as shown. The torch head 32 includes an anode body 40 that is in electrical communication with the positive side of a power supply (not shown), and a cathode 42 that is in electrical communication with the negative side of the power supply. The cathode 42 is further surrounded by a central insulator 44 to insulate the cathode 42 from the anode body 40, and similarly, the anode body 40 is surrounded by an outer insulator 46 to insulate the anode body 40 from a housing 48, which encapsulates and protects the torch head 32 and its components from the surrounding environment during operation. The torch head 32 is further adjoined with a coolant supply tube 50, a plasma gas tube 52, a coolant return tube 54, and a secondary gas tube 56, wherein plasma gas and secondary gas are supplied to and cooling fluid is supplied to and returned from the plasma arc torch 30 during operation as further shown and described in co-pending application Ser. No. 10/409,650, titled “Plasma Arc Torch,” filed Apr. 7, 2003, which is commonly owned with the present application and the contents of which are incorporated by reference herein in their entirety.

It should be understood that the plasma arc torch 30 as illustrated and described herein is exemplary only, and other types of plasma arc torches, such as hand cutting plasma arc torches may also be employed according to the teachings of the present invention. Such a hand cutting torch is shown and described in co-pending application Ser. No. 10/084,009, titled “Contact Start Plasma Arc Torch and Method of Initiating a Pilot Arc,” filed Feb. 26, 2002, which is commonly owned with the present application and the contents of which are incorporated by reference herein in their entirety.

The other components that are disposed at the distal end 38 of the plasma arc torch 30 comprise an electrode 60, a tip 62, and a spacer 64 (also referred to as a “gas distributor”) disposed between the electrode 60 and the tip 62 as shown. The components further comprise a cartridge body 66, which generally houses and positions the other components and also distributes plasma gas, secondary gas, and cooling fluid during operation of the plasma arc torch 30. Additionally, the components comprise a distal anode member 68 and a central anode member 70 to form a portion of the anodic side of the power supply by providing electrical continuity to the tip 62. A baffle 72 is also shown disposed between the distal anode member 68 and a shield cap 74, which forms fluid passageways for the flow of a cooling fluid. Further, the components comprise a secondary cap 76 for the distribution of the secondary gas and a secondary spacer 78 that separates the secondary cap 76 from the tip 62. A locking ring 80 is shown disposed around the proximal end portion of the components, which is used to secure the components to the torch head 32. Additionally, a tip guide 82 and a tip seal 84 are disposed at the distal end portion of the tip 62 as shown and provide certain cooling fluid distribution and sealing functions.

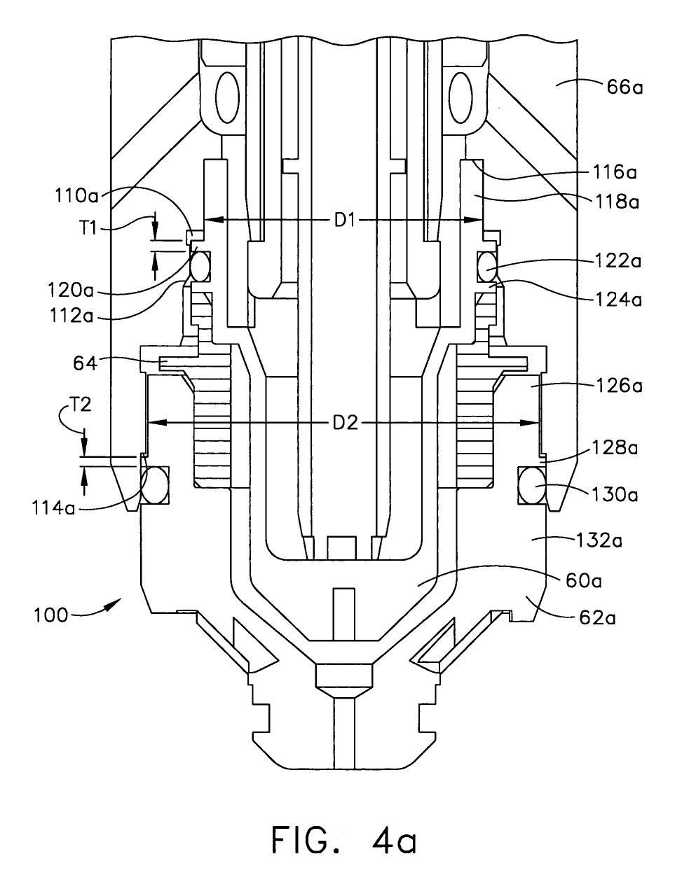

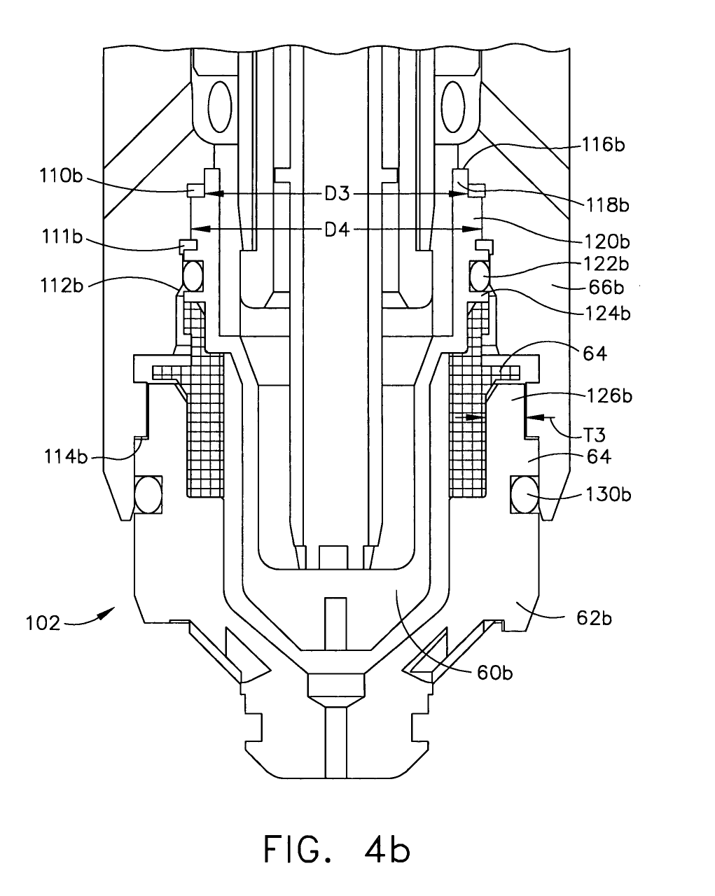

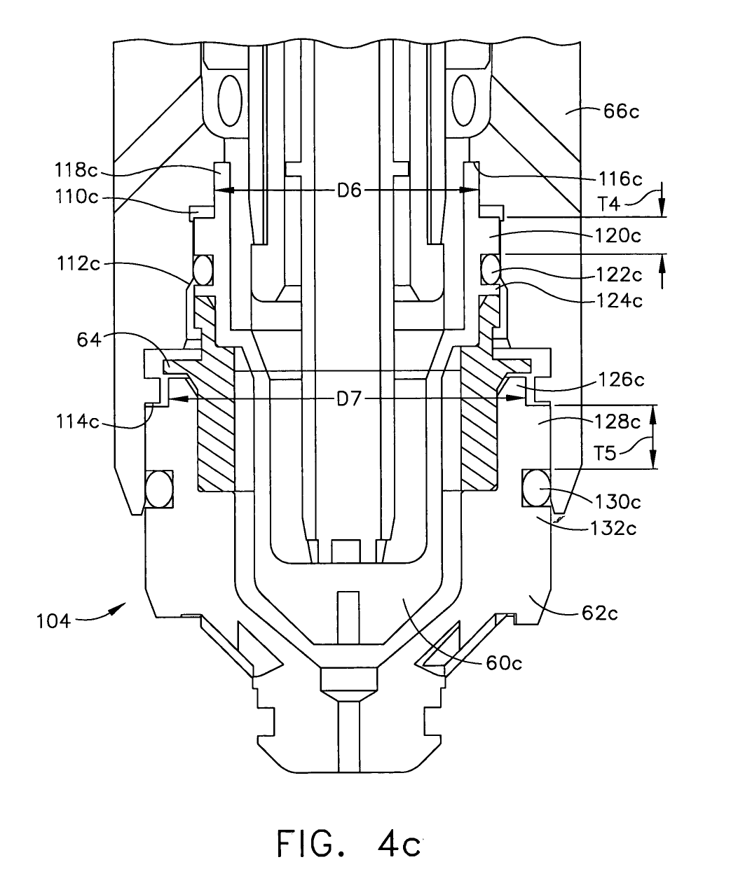

Accordingly, the plasma arc torch 30 as illustrated and described above is a single plasma arc torch model that comprises certain components, or parts, that have design features which are varied in order to provide different sets of parts to different distributors such that the parts are not interchangeable and the different distributors can maintain separate inventories of plasma arc torch parts. These design features of the plasma arc torch components that are varied in one form of the present invention are now described in greater detail with reference to FIGS. 4a-4c.

As shown, three sets of parts for the single plasma arc torch model 30 are illustrated in FIGS. 4a (first set 100), 4b (second set 102), and 4c (third set 104). The first set of parts 100 comprise a torch head 32a, an electrode 60a, a tip 62a, a spacer 64a, and a cartridge body 66a. Similarly, the second set of parts 102 comprise a torch head 32b, an electrode 60b, a tip 62b, a spacer 64b, and a cartridge body 66b, and the third set of parts 104 comprise a torch head 32c, an electrode 60c, a tip 62c, a spacer 64c, and a cartridge body 66c. Generally, the design features that are varied include reliefs within the cartridge bodies 66a, 66b, 66c, which are illustrated as 110a in the first set of parts 100, 110b and 111b in the second set of parts 102, and 110c in the third set of parts 104. Combined with features of the electrodes 60a-c and the tips 62a-c, these reliefs facilitate a cooling fluid leak when an incompatible set of parts are installed, e.g., when the second electrode 60b is installed within the first cartridge body 66a, which are described in greater detail below.

In the first set of parts 100 as shown in FIG. 4a, the cartridge body 66a comprises a relief 110a and an angled inner wall 112a disposed distally from the relief 110a. The cartridge body 66a further comprises a distal shoulder 114a as shown. The electrode 60a from the first set of parts 100 comprises a proximal face 116a, proximal side wall 118a defining an outer diameter D1, a proximal annular extension 120a defining a thickness T1, and an o-ring 122a disposed between the proximal annular extension 120a and a distal annular extension 124a. Similarly, the tip 62a from the first set of parts 100 comprises a proximal side wall 126a defining an outer diameter D2, a proximal annular extension 128a a defining a thickness T2, and an o-ring 120a disposed between the proximal annular extension 128a and a distal annular extension 132a. When the electrode 60a and the tip 62a are disposed within the cartridge body 66a, the o-rings 122a and 120a engage the cartridge body 66a as shown to seal the cooling fluid and also to isolate the cooling fluid from the plasma gas.

In the second set of parts 102 as shown in FIG. 4b, the cartridge body 66b comprises a first relief 110b and a second relief 111b, and an angled inner wall 112b disposed distally from the reliefs 110b and 111b. The cartridge body 66b further comprises a distal shoulder 114b as shown. The electrode 60b from the second set of parts 102 comprises a proximal face 116b, proximal side wall 118b defining an outer diameter D3, a proximal annular extension 120b defining an outer diameter D4, and an o-ring 122b disposed between the proximal annular extension 120b and a distal annular extension 124b. Similarly, the tip 62b from the second set of parts 102 comprises a proximal side wall 126b defining an outer diameter D5, a proximal annular extension 128b a defining a thickness T3, and an o-ring 130b disposed between the proximal annular extension 128b and a distal annular extension 132b. When the electrode 60b and the tip 6ba are disposed within the cartridge body 66b, the o-rings 122b and 130b engage the cartridge body 66b as shown to seal the cooling fluid and also to isolate the cooling fluid from the plasma gas.

In the third set of parts 104 as shown in FIG. 4c, the cartridge body 66c comprises a relief 110c and an angled inner wall 112c disposed distally from the relief 110c. The cartridge body 66c further comprises a distal shoulder 114c as shown. The electrode 60c from the third set of parts 104 comprises a proximal face 116c, proximal side wall 118c defining an outer diameter D6, a proximal annular extension 120c defining a thickness T4, and an o-ring 122c disposed between the proximal annular extension 120c and a distal annular extension 124c. Similarly, the tip 62c from the third set of parts 104 comprises a proximal side wall 126c defining an outer diameter D7, a proximal annular extension 128c a defining a thickness T5, and an o-ring 130c disposed between the proximal annular extension 128c and a distal annular extension 132c. When the electrode 60c and the tip 62c are disposed within the cartridge body 66c, the o-rings 122c and 130c engage the cartridge body 66c as shown to seal the cooling fluid and also to isolate the cooling fluid from the plasma gas.

Accordingly, each of the cartridge bodies 66a-c, electrodes 60a-c, and tips 62a-c define slightly different features for each of the first set of parts 100, second set of parts 102, and third set of parts 104, which operate within a single plasma arc torch model. Therefore, due to these different design features, the first set of parts 100, second set of parts 102, and third set of parts 104 are not interchangeable with one another due to physical interferences and gaps such that if the incorrect set of parts are installed, a cooling fluid leak develops as shall be described in the following figures. Additionally, flow of the cooling fluid is illustrated with the heavy arrows as shown throughout the following figures.

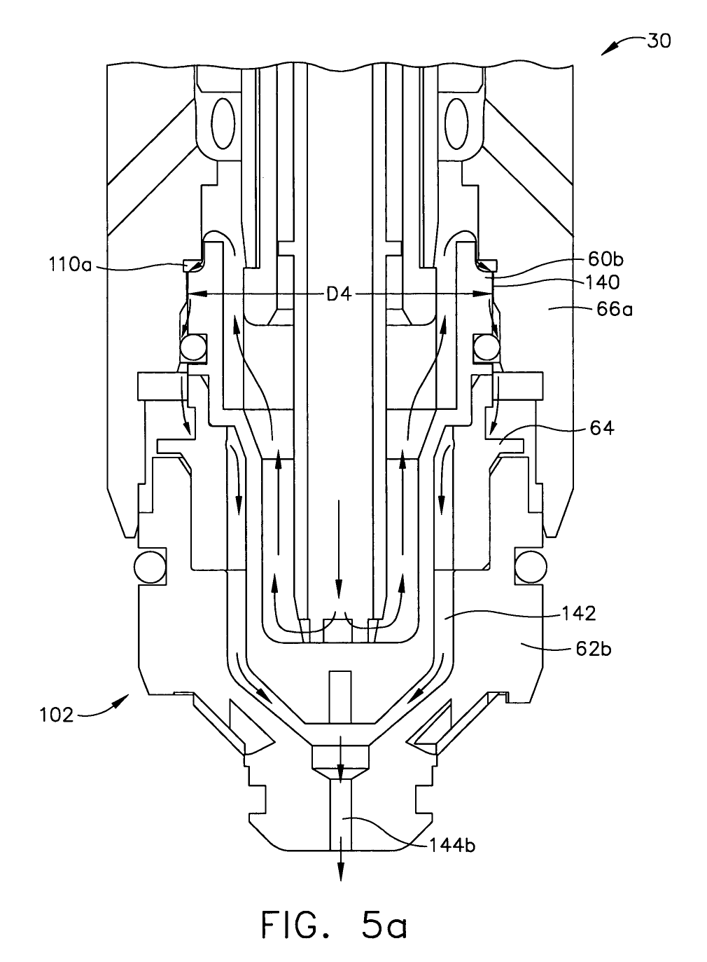

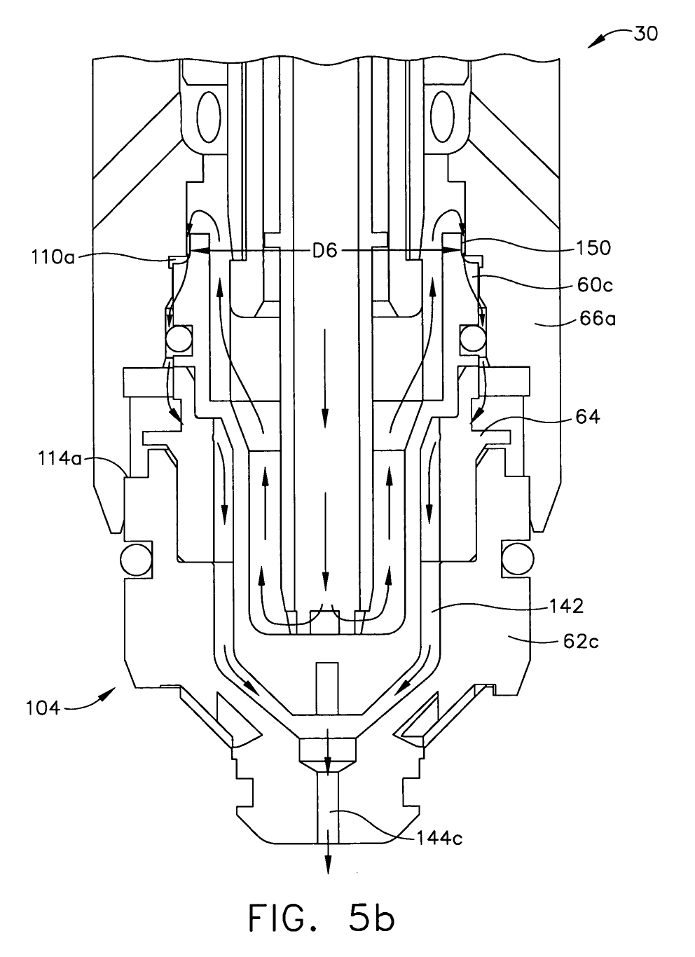

FIGS. 5a and 5b illustrate the first cartridge body 66a with an incorrect second set of parts 102 (electrode 60b and tip 62b) and third set of parts 104 (electrode 60c and tip 62c), respectively. Reference is also made to FIG. 4a, which illustrates the first cartridge body 66a with the correct first set of parts 100. As shown in FIG. 5a, the diameter D4 of the electrode 60b is smaller than the corresponding diameter of the correct electrode (60a), which causes a gap 140 between the electrode 60b and the cartridge body 66a. Combined with the relief 110a, the gap 140 provides a passageway for cooling fluid to leak into the plasma chamber 142 and out through the orifice 144b formed in the tip 62b as illustrated by the flow arrows. Therefore, when an incorrect set of parts are installed, the plasma arc torch 30 becomes inoperable due to the cooling fluid leak. Similarly, as shown in FIG. 5b, when the third set of parts 104 are installed within the first cartridge body 66a, a similar cooling fluid leak develops. The tip 62c physically interferes with the distal shoulder 114a of the cartridge body 66a, and the diameter D6 of the electrode 60c is smaller than the corresponding diameter of the correct electrode (60a), which results in a gap 150 between the electrode 60c and the cartridge body 66a. Combined with the relief 110a, the gap 150 provides a passageway for cooling fluid to leak into the plasma chamber 142 and out through the orifice 144c formed in the tip 62c, thereby rendering the plasma arc torch 30 inoperable.

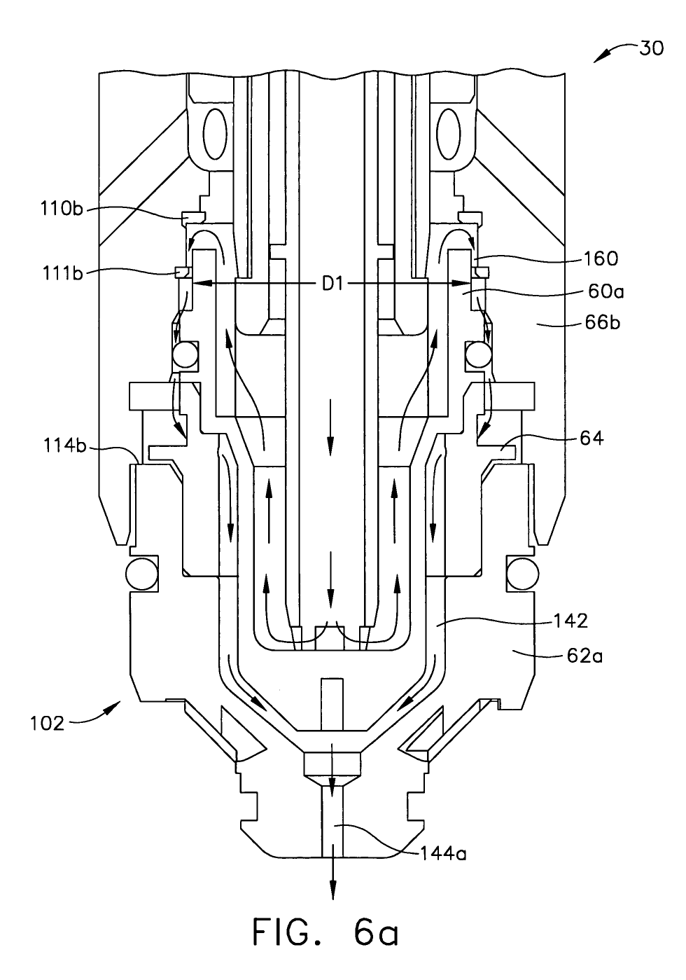

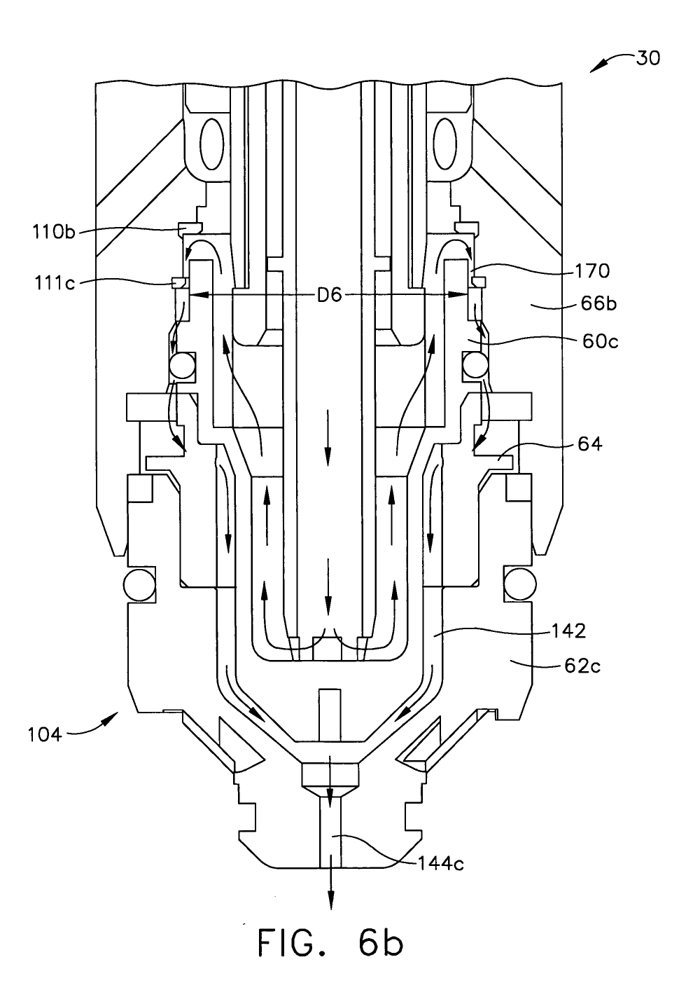

FIGS. 6a and 6b illustrate the second cartridge body 66b with an incorrect first set of parts 100 (electrode 60a and tip 62a) and third set of parts 104 (electrode 60c and tip 62c), respectively. Reference is also made to FIG. 4b, which illustrates the second cartridge body 66b with the correct second set of parts 102. As shown in FIG. 6a, the tip 62a physically interferes with the distal shoulder 114b of the cartridge body 66b, and the diameter D1 of the electrode 60a is smaller than the corresponding diameter of the correct electrode (60b), which causes a gap 160 between the electrode 60a and the cartridge body 66b. Combined with the reliefs 110b and 111b, the gap 160 provides a passageway for cooling fluid to leak into the plasma chamber 142 and out through the orifice 144a formed in the tip 62a as illustrated by the flow arrows. Therefore, when an incorrect set of parts are installed, the plasma arc torch 30 becomes inoperable due to the cooling fluid leak. Similarly, as shown in FIG. 6b, when the third set of parts 104 are installed within the second cartridge body 66b, a similar cooling fluid leak develops. The diameter D6 of the electrode 60c is smaller than the corresponding diameter of the correct electrode (60b), which results in a gap 170 between the electrode 60c and the cartridge body 66b. Combined with the reliefs 110b and 111b, the gap 170 provides a passageway for cooling fluid to leak into the plasma chamber 142 and out through the orifice 144c formed in the tip 62c, thereby rendering the plasma arc torch 30 inoperable.

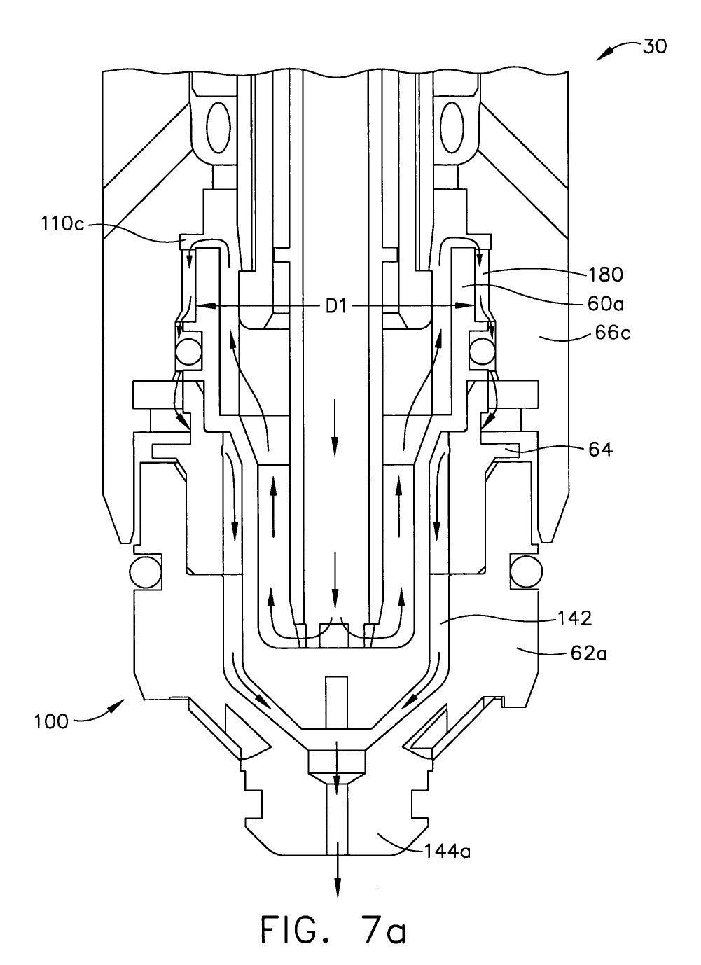

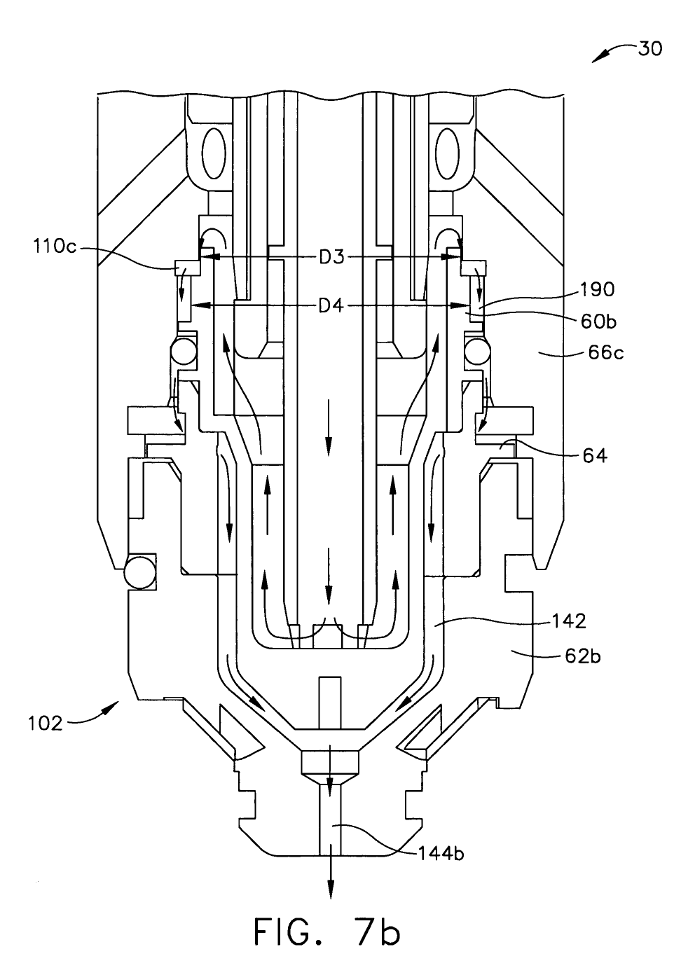

FIGS. 7a and 7b illustrate the third cartridge body 66c with an incorrect first set of parts 100 (electrode 60a and tip 62a) and second set of parts 102 (electrode 60b and tip 62b), respectively. Reference is also made to FIG. 4c, which illustrates the third cartridge body 66c with the correct third set of parts 104. As shown in FIG. 7a, the diameter D1 of the electrode 60a is smaller than the corresponding diameter of the correct electrode (60c), which causes a gap 180 between the electrode 60a and the cartridge body 66c. Combined with the relief 110c, the gap 180 provides a passageway for cooling fluid to leak into the plasma chamber 142 and out through the orifice 144a formed in the tip 62a as illustrated by the flow arrows. Therefore, when an incorrect set of parts are installed, the plasma arc torch 30 becomes inoperable due to the cooling fluid leak. Similarly, as shown in FIG. 7b, when the second set of parts 102 are installed within the third cartridge body 66c, a similar cooling fluid leak develops. The diameter D4 of the electrode 60b is smaller than the corresponding diameter of the correct electrode (60c), which results in a gap 190 between the electrode 60b and the cartridge body 66c. Additionally, fluid is able to flow between the cartridge body 66c and the outer diameter of the electrode D3 in order to reach the gap 190. Combined with the relief 110c, the gap 190 provides a passageway for cooling fluid to leak into the plasma chamber 142 and out through the orifice 144b formed in the tip 62b, thereby rendering the plasma arc torch 30 inoperable.

It should be understood that the incorrect parts as illustrated above could also include other combinations of incorrect parts, for example, a cartridge body 66a from the first set of parts 100, an electrode 60b from the second set of parts 102, and a tip 62c from the third set of parts, which would also result in the cooling fluid leak. Accordingly, the embodiments illustrated herein are exemplary and should not be construed as limiting the scope of the present invention.

As further shown, the spacer 64 is the same part for each of the first, second, and third sets of parts, 100, 102, 104, respectively. Since this same part is manufactured for use by different distributors, the color of the spacer 64 may be varied in another form of the present invention to further maintain separate inventories for each parts distributor without varying any physical attributes of the spacer 64. For example, the spacer 64a as shown in FIG. 4a may be blue for the first distributor, the spacer 64b as shown in FIG. 4b may be yellow for the second distributor, and the spacer 64c as shown in FIG. 4c may be green for the third distributor. Such a color coding system is further shown and described in co-pending application Ser. No. 10/719,328, titled “Color Coding of Plasma Arc Torch Parts and Part Sets,” filed Nov. 21, 2003, which is commonly assigned with the present application and the contents of which are incorporated herein by reference in their entirety.

As used herein, a plasma arc torch, whether operated manually or automated, should be construed by those skilled in the art to be an apparatus that generates or uses plasma for cutting, welding, spraying, gouging, or marking operations, among others. Further, the plasma arc torch may be manual, automated, single gas, multiple gas, air cooled, or liquid cooled, among other variations in plasma arc torches. Accordingly, the specific reference to plasma arc cutting torches, plasma arc torches, or manually operated plasma arc torches herein should not be construed as limiting the scope of the present invention. Additionally, the present invention may also be employed with other torches that are not specifically plasma, which include but are not limited to, MIG (metal inert gas), TIG (tungsten inert gas), or gas welding and cutting. Furthermore, the specific reference to providing gas to a plasma arc torch or other torch should not be construed as limiting the scope of the present invention, such that other fluids, e.g. liquids, or solids such as powder or wire for spraying operations, may also be provided to the plasma arc torch in accordance with the teachings of the present invention.

The description of the invention is merely exemplary in nature and, thus, variations that do not depart from the substance of the invention are intended to be within the scope of the invention. For example, other geometrical features may be varied in order to provide incompatible set of parts such that a cooling fluid leak develops when an incorrect set of parts are installed. Accordingly, the reliefs and other geometrical features and dimensions as illustrated and described herein should not be construed as limiting the scope of the present invention. Such variations are not to be regarded as a departure from the spirit and scope of the invention.

1. In a plasma arc torch parts distribution network, a method of providing plasma arc torch parts for use in a single plasma arc torch model through a plurality of distributors and distribution channels, the method comprising the steps of:
(a) providing a first set of plasma arc torch parts to a first distributor; and
(b) providing a second set of plasma arc torch parts to a second distributor,
wherein the first set of plasma arc torch parts are not interchangeable with the second set of plasma arc torch parts such that the first and second distributors maintain separate inventories of plasma arc torch parts.

2. The method according to claim 1 further comprising the step of providing a third set of plasma arc torch parts to a third distributor, wherein the first, second, and third set of plasma arc torch parts are not interchangeable such that the first, second, and third distributors maintain separate inventories of plasma arc torch parts.

3. The method according to claim 1, wherein at least one of the distributors is an original equipment manufacturer.

4. The method according to claim 1, further comprising the step of establishing a first pricing structure for the first distributor and a second pricing structure for the second distributor.

5. The method according to claim 1, wherein sales of at least one of the distributors is geographically limited.

6. The method according to claim 1, wherein at least one of the first distributor or the second distributor sell their respective sets of parts to another distributor for final sale to an end user.

7. In a plasma arc torch parts distribution network, a method of providing plasma arc torch parts for use in a single plasma arc torch model through a plurality of distributors and distribution channels, the method comprising the steps of:
(a) providing a first set of plasma arc torch parts to a replacement parts distributor;
(b) providing a second set of plasma arc torch parts to an original equipment manufacturer; and
(c) providing a third set of plasma arc torch parts to a select original equipment manufacturer,
wherein the first, second, and third set of plasma arc torch parts are not interchangeable such that the replacement parts distributor, the original equipment manufacturer, and the select original equipment manufacturer maintain separate inventories of plasma arc torch parts.

8. The method according to claim 7, wherein at least one of the distributors is an original equipment manufacturer.

9. The method according to claim 7, further comprising the step of establishing at least a first pricing structure for the first distributor and a second pricing structure for the second distributor.

10. The method according to claim 7, wherein sales of at least one of the distributors is geographically limited.

11. The method according to claim 7, wherein at least one of the first distributor, the second distributor, or the third distributors sell their respective sets of parts to another distributor for final sale to an end user.

12. A series of plasma arc torch parts for use by a plurality of distributors in a single plasma arc torch model, the series comprising:
a first set of plasma arc torch parts for use by a first distributor;
a second set of plasma arc torch parts for use by a second distributor; and
a third set of plasma arc torch parts for use by a third distributor,
wherein the first, second, and third set of plasma arc torch parts comprise respective design features that are varied such that the first, second, and third set of plasma arc torch parts are not interchangeable, thereby causing a failure of the plasma arc torch.

13. The series of plasma arc torch parts according to claim 12, wherein the plasma arc torch parts are selected from a group consisting of cartridge bodies, electrodes, gas distributors, tips, baffles, distal anode bodies, tip guides, tip seals, secondary caps, secondary spacers, shield caps, shield cups, start cartridges, torch heads, and torch leads.

14. The series of plasma arc torch parts according to claim 12, wherein the failure is selected from a group consisting of a cooling fluid leak, a gas leak, physical interferences, physical gaps, electrical gaps, prevention of engagement of a parts-in-place switch, failure to match electronic keys, and failure to match magnetic keys.

15. The series of plasma arc torch parts according to claim 12, wherein the first set of plasma arc torch parts comprises a first electrode and a first tip adapted for engagement with a first cartridge body and the second set of plasma arc torch parts comprises a second electrode and a second tip adapted for engagement with a second cartridge body, wherein the first electrode and the first tip are incompatible with the second cartridge body, and the second electrode and the second tip are incompatible with the first cartridge body such that the plasma arc torch develops a cooling fluid leak when the first electrode and the first tip are engaged with the second cartridge body and when the second electrode and the second tip are engaged with the first cartridge body.

16. The series of plasma arc torch parts according to claim 12, wherein the first set of plasma arc torch parts comprises a first cartridge body and a first torch head, and the second set of plasma arc torch parts comprises a second cartridge body and a second torch head, wherein the first cartridge body is incompatible with the second torch head, and the second cartridge body is incompatible with the first torch head such that the plasma arc torch develops a cooling fluid leak when the first cartridge body is engaged with the second torch head and when the second cartridge body is engaged with the first torch head.

17. The series of plasma arc torch parts according to claim 12, further comprising a plurality of common parts that are interchangeable between the first and second sets of plasma arc torch parts, wherein the common parts define different colors for each of the first and second sets of plasma arc torch parts.

18. A system for inhibiting use of an incorrect set of replacement parts in a plasma arc torch, the system comprising:
a first set of replacement parts defining a first set of design features;
a second set of replacement parts defining a second set of design features; and
a third set of replacement parts defining a third set of design features,
wherein the first, second, and third set of design features are not interchangeable such that the plasma arc torch becomes non-functional to inhibit further use of the plasma arc torch.

19. The system according to claim 18, wherein the replacement parts are selected from a group consisting of cartridge bodies, electrodes, gas distributors, tips, baffles, distal anode bodies, tip guides, tip seals, secondary caps, secondary spacers, shield caps, shield cups, start cartridges, torch heads, and torch leads.

20. The system according to claim 19, wherein the cartridge bodies further comprise reliefs to facilitate the cooling fluid leak.

21. The series of plasma arc torch parts according to claim 18, wherein the plasma arc torch becomes non-functional through a failure selected from a group consisting of a cooling fluid leak, a gas leak, physical interferences, physical gaps, electrical gaps, prevention of engagement of a parts-in-place switch, failure to match electronic keys, and failure to match magnetic keys.

22. The series of plasma arc torch parts according to claim 18 further comprising a plurality of common parts that are interchangeable between the first, second, and third sets of replacement parts, wherein the common parts define different colors for each of the first, second, and third set of replacement parts.
